(19) United States
(12) Patent Application Publication
(10) Pub. No.: US 2020/0192048 A1
(43) Pub. Date: Jun. 18, 2020

(54) BASE COMPONENT, FAN-OUT CORD, AND METHOD OF MANUFACTURING FAN-OUT CORD

(71) Applicant: SEI Optifrontier Co., Ltd., Yokohama-shi (JP)

(72) Inventors: Yohei AOSHIMA, Yokohama-shi (JP); Daizo NISHIOKA, Yokohama-shi (JP); Yoshikyo TAMEKUNI, Yokohama-shi (JP)

(73) Assignee: SEI Optifrontier Co., Ltd., Yokohama-shi (JP)

(21) Appl. No.: 16/714,852

(22) Filed: Dec. 16, 2019

(30) Foreign Application Priority Data
Dec. 17, 2018 (JP) 2018-235412

(51) Int. Cl. G02B 6/44

(52) U.S. Cl. CPC G02B 6/4476; G02B 6/4472; G02B 6/4486; G02B 6/4432

(57) ABSTRACT

An inner component used for a fan-out cord includes a first fixing portion that fixes a reinforcing tube that accommodates a plurality of optical fibers and a tension fiber, at least one second fixing portion that fixes a plurality of reinforcing tubes each of which accommodates at least one of the plurality of optical fibers, and an accommodation portion that accommodates the plurality of optical fibers exposed from the reinforcing tubes between the first fixing portion and the at least one second fixing portion.

### CROSS-REFERENCE TO RELATED APPLICATIONS

This application claims priority from Japanese Patent Application No. 2018-235412, filed on Dec. 17, 2018, the entire subject matter of which is incorporated herein by reference.

### TECHNICAL FIELD

The present invention relates to a base component for a fan-out cord, a fan-out cord including the base component, and a method of manufacturing a fan-out cord.

### BACKGROUND ART

JP-A-H10-177123 discloses a branch splicing apparatus for optical fibers including a plurality of optical fibers, a gathering portion, and a protective fixing member. The branch splicing apparatus is manufactured by stripping the coating from one end portion of each optical fiber, gathering and integrally coating the end portions from which the coating has been stripped with a coating material for gathering to form a gathering portion, and mounting the protective fixing member on a branch portion at which the optical fibers are branched from the gathering portion to fix the branch portion. The protective fixing member is, for example, a thermal shrinkable sleeve.

In addition, JP-A-2003-302558 discloses a multi-core optical connector including an optical fiber cord, a plurality of optical fiber ribbons, and a protective fixing member. The multi-core optical connector is manufactured by inserting each of a plurality of optical fiber ribbons exposed and branched from an optical fiber cord into a reinforcing tube respectively, and mounting a protective fixing member on a connection portion between the optical fiber cord and each of the reinforcing tubes to fix the connection portion. The protective fixing member is, for example, a thermally shrinkable tube.

### SUMMARY OF INVENTION

In the branch splicing apparatus disclosed in JP-A-H10-177123, the branch portion may move within the thermal shrinkable sleeve to be exposed from the thermal shrinkable sleeve while heating the thermal shrinkable sleeve to shrink after mounting the thermal shrinkable sleeve on the branch portion. Therefore, the thermal shrinkable sleeve needs to be formed to be longer than the length of the branch portion by a predetermined length, and thus the entire size of the branch splicing apparatus increases.

In addition, even in the multi-core optical connector disclosed in JP-2003-302558, it is necessary that the thermally shrinkable tube is formed to be longer than the connection portion between the optical fiber cord and each of the reinforcing tubes by a predetermined distance, and thus the entire size of the multi-core optical connector increases.

An object of the present invention is to provide a base component used for a compact fan-out cord, a fan-out cord, and a method of manufacturing a fan-out cord.

An aspect of the present invention is a base component used for a fan-out cord, the base component includes a main body portion and the main body portion comprising:

a first fixing portion that fixes a first tube accommodating a plurality of optical fibers and a tensile strength member;

at least one second fixing portion that fixes a plurality of second tubes each of which accommodates at least one of the plurality of optical fibers;

an engagement portion that engages with the tensile strength member exposed from the first tube; and

an accommodation portion that accommodates the plurality of optical fibers exposed from each of the first tube and the plurality of second tubes between the first fixing portion and the at least one second fixing portion.

Another aspect of the present invention is a fan-out cord comprising:

a plurality of optical fibers;

a first tube that accommodates the plurality of optical fibers and a tensile strength member;

a plurality of second tubes each of which accommodates at least one of the plurality of optical fibers; and

a base component that fixes the first tube and the plurality of second tubes, wherein

the base component includes a main body portion and the main body portion includes

a first fixing portion that fixes the first tube,

at least one second fixing portion that fixes the plurality of second tubes,

an engagement portion that engages with the tensile strength member exposed from the first tube, and

an accommodation portion that accommodates the plurality of optical fibers exposed from each of the first tube and the plurality of second tubes between the first fixing portion and the at least one second fixing portion.

Another aspect of the present invention is a method of manufacturing a fan-out cord, the method comprising:

a step of accommodating a plurality of optical fibers in a first tube;

a step of accommodating each of at least one of the plurality of optical fibers in a plurality of second tubes;

a step of fixing the first tube to a base component;

a step of engaging a tensile strength member accommodated in the first tube with the base component; and

a step of fixing the plurality of second tubes to the base component.

According to the present invention, a base component used for a compact fan-out cord, a fan-out cord, and a method of manufacturing a fan-out cord can be provided.

### BRIEF DESCRIPTION OF DRAWINGS

FIG. 1 is a perspective view illustrating a fan-out cord according to an embodiment of the present invention;

FIG. 2 is an exploded perspective view illustrating the fan-out cord of FIG. 1;

FIG. 3A is a cross-sectional view illustrating a reinforcing tube used in the fan-out cord;

FIG. 3B is a cross-sectional view illustrating a reinforcing tube used in the fan-out cord;

FIG. 4 is a partial cross-sectional view illustrating the fan-out cord of FIG. 1;

FIG. 5A is a perspective view illustrating a main body portion of an inner component according to the embodiment of the present invention;

FIG. 5B is a diagram illustrating the main body portion of the inner component when seen from a first fixing portion side;

FIG. 5C is a diagram illustrating the main body portion of the inner component when seen from a second fixing portion side;

FIG. 6 is a rear perspective view illustrating a cover member of the inner component;

FIG. 7 is a perspective view illustrating an outer front portion of an outer component;

FIG. 8 is a perspective view illustrating an outer rear portion of the outer component;

FIG. 9 is a diagram illustrating an optical fiber accommodation step in a method of manufacturing the fan-out cord;

FIG. 10 is a diagram illustrating a reinforcing tube attachment step in the method of manufacturing the fan-out cord;

FIG. 11 is a diagram illustrating the reinforcing tube attachment step in the method of manufacturing the fan-out cord;

FIG. 12 is a diagram illustrating the reinforcing tube attachment step in the method of manufacturing the fan-out cord;

FIG. 13 is a diagram illustrating a cover member attachment step in the method of manufacturing the fan-out cord;

FIG. 14 is a diagram illustrating a tension fiber adhesion step in the method of manufacturing the fan-out cord;

FIG. 15 is a diagram illustrating an outer rear portion attachment step in the method of manufacturing the fan-out cord; and

FIG. 16 is a diagram illustrating an outer front portion attachment step in the method of manufacturing the fan-out cord.

### DESCRIPTION OF EMBODIMENTS

### Description of Embodiment of Present Invention

First, the contents of an embodiment of the present invention will be described.

A base component used in a fan-out cord according to one aspect of the present invention includes a main body portion and the main body portion includes:

(1) a first fixing portion that fixes a first tube accommodating a plurality of optical fibers and a tensile strength member;

at least one second fixing portion that fixes a plurality of second tubes each of which accommodates at least one of the optical fibers;

an engagement portion that engages with a tensile strength member exposed from the first tube; and

an accommodation portion that is provided between the first fixing portion and the at least one second fixing portion to accommodate the optical fibers exposed from the first tube and the second tube.

In this configuration, the first tube and the second tube are fixed to the base component using the first fixing portion and the at least one second fixing portion. Therefore, since the first tube and the second tube do not move in the base portion when the vicinity of the base component is covered with a protective material, the length of the protective material can be reduced. As a result, the compact fan-out cord can be provided.

(2) The at least one second fixing portion may be a plurality of second fixing portions which fix each of the plurality of second tubes.

In this configuration, the second tubes are fixed to the second fixing portions corresponding thereto, respectively. Therefore, the second tubes can be individually positioned.

(3) Multiple stages of second fixing portion groups in which at least two of the plurality of second fixing portions are arranged adjacent to each other may be disposed.

In this configuration, multiple stages of second fixing portion groups in which at least two of the second fixing portions are arranged adjacent to each other are disposed. Therefore, the base component can be made compact.

(4) The first fixing portion may have a first recessed portion for positioning the first tube, and each of the second fixing portions has a plurality of second recessed portions for positioning the second tubes.

In this configuration, the first fixing portion and the second fixing portion have the recessed portions. Therefore, the positioning operation of the first tube and the second tube can be easily performed.

(5) The base component may further include a cover member that is attachable to and detachable from the main body portion.

In this configuration, the base portion includes the main body portion and the cover member. Therefore, in a state where the cover member is separated, the first tube and the second tube can be attached to the main body portion. As a result, the attachment operation of the first tube and the second tube can be easily performed.

(6) In addition, a fan-out cord according to an embodiment of the present invention includes:

a plurality of optical fibers;

a first tube that accommodates the plurality of optical fibers and a tensile strength member;

a plurality of second tubes each of which accommodates at least one of the plurality of optical fibers; and

a base component that fixes the first tube and the second tubes,

in which the base component includes

a first fixing portion that fixes the first tube,

a second fixing portion that fixes the second tubes,

an engagement portion that engages with the tensile strength member exposed from the first tube; and

an accommodation portion that is provided between the first fixing portion and the at least one second fixing portion to accommodate the optical fibers exposed from each of the first tube and the plurality of second tubes.

In this configuration, the first tube and the second tube are fixed to the base component. Therefore, since the first tube and the second tube do not move within the base portion when the vicinity of the base component is covered with a protective material, the length of the protective material can be reduced. As a result, the compact fan-out cord can be provided.

(7) The fan-out cord may further include a protective material that covers the vicinity of the base component.

In this configuration, the vicinity of the base component is covered with the protective material. Therefore, the base component can be protected. In addition, since the first tube and the second tube do not move within the base portion when the vicinity of the base component is covered with the protective material, the length of the protective material can be reduced.

(8) The protective material may include two components that are engageable with each other.

In this configuration, the protective material includes two components. Therefore, the attachment operation of the protective material can be easily performed.

(9) The protective material may include a first through-hole into which the first tube is inserted and a second through-hole into which the second tubes are inserted.

In this configuration, the protective material includes the respective through-holes into which the first tube and the second tube are inserted. Therefore, the attachment operation of the protective material can be easily performed.

(10) In addition, a method of manufacturing a fan-out cord according to an embodiment of the present invention includes:

a step of accommodating a plurality of optical fibers in a first tube;

a step of accommodating each of at least one of the plurality of optical fibers in a plurality of second tubes;

a step of fixing the first tube to a base component;

a step of engaging a tensile strength member accommodated in the first tube with the base component; and

a step of fixing the plurality of second tubes to the base component.

In this configuration, each of the first tube and the second tube are fixed to the base component. Therefore, since the first tube and the second tube do not move within the base portion when the vicinity of the base component is covered with a protective material, the length of the protective material can be reduced. As a result, the compact fan-out cord can be manufactured. In addition, since the tensile strength member engages with the base component, the manufacturing operation of the second tube such as the fixing operation can be efficiently performed.

(11) The method of manufacturing a fan-out cord may further include

a step of covering the vicinity of the base component with a protective material.

In this configuration, the vicinity of the base component is covered with the protective material. Therefore, the base component can be protected with the protective material.

### Details of Embodiment of Present Invention

Hereinafter, the embodiment of the present invention (hereinafter, referred to as “the embodiment”) will be described in detail with reference to the accompanying drawings. In the description of the drawings, the same or equivalent components will be denoted with the same reference numerals, and the description thereof will be omitted.

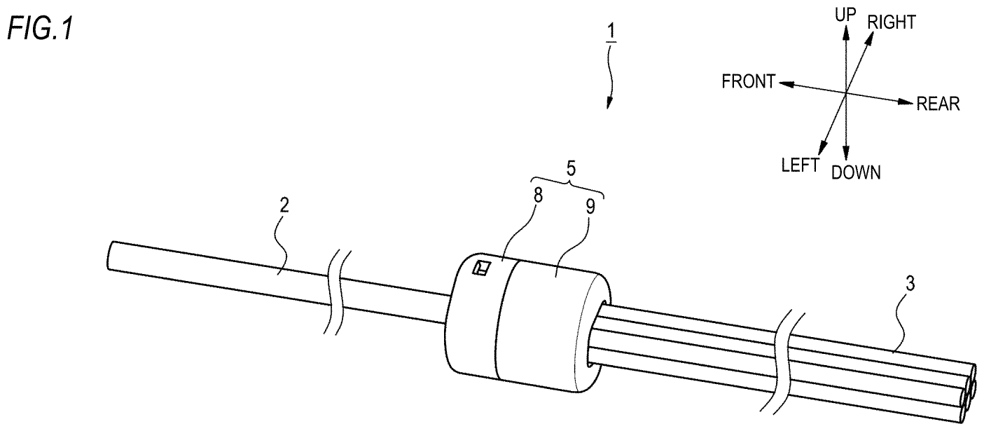

In addition, in the description of the embodiment, for convenience of description, “left-right direction”, “up-down direction”, and “front-rear direction” will be appropriately described. These directions are relative directions when seen from a fan-out cord 1 illustrated in FIG. 1. Here, “left-right direction” refers to a direction including “left direction” and “right direction”. Here, “up-down direction” refers to a direction including “up direction” and “down direction”. “Front-rear direction” refers to a direction including “front direction” and “rear direction”. The left-right direction refers to a direction perpendicular to the up-down direction. The front-rear direction refers to a direction perpendicular to the left-right direction and the up-down direction. The “front direction” refers to a reinforcing tube 2 side in a longitudinal direction of the fan-out cord 1, and the “rear direction” refers to a reinforcing tube 3 side in the longitudinal direction of the fan-out cord 1.

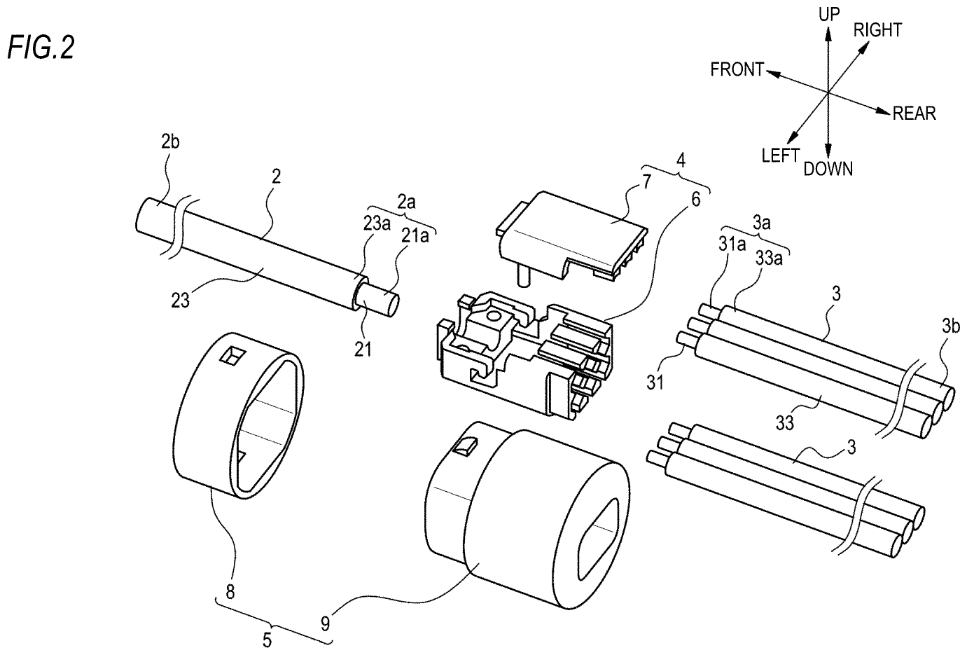

FIG. 1 is a perspective view illustrating the fan-out cord 1 according to the embodiment. FIG. 2 is an exploded perspective view illustrating the fan-out cord 1 of FIG. 1. FIG. 2 does not illustrate an optical fiber 10 and tension fibers 22 and 32 (an example of the tensile strength member).

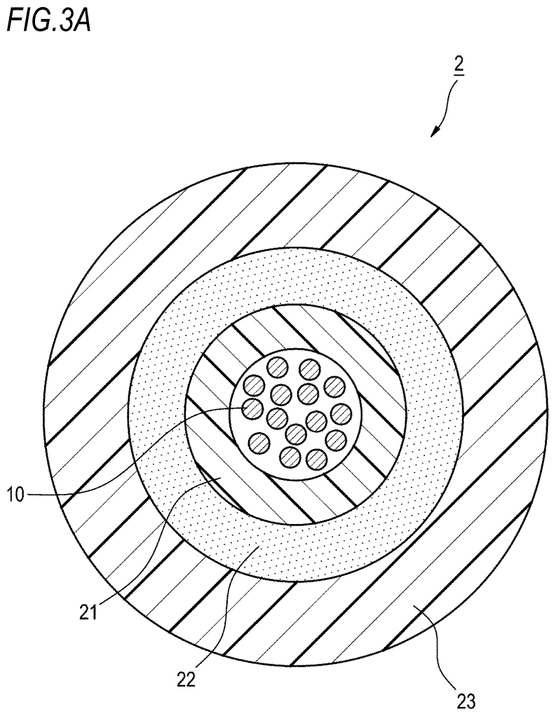

As illustrated in FIGS. 1 and 2, the fan-out cord 1 includes the reinforcing tube 2, a plurality of reinforcing tubes 3, an inner component 4, and an outer component 5. In addition, the fan-out cord 1 includes a plurality of optical fibers 10 (refer to FIGS. 3A and 3B). The reinforcing tube 2 is an example of the first tube. The reinforcing tube 3 is an example of the second tube. The inner component 4 is an example of the base component. The outer component 5 is an example of the protective material.

The reinforcing tube 2 accommodates a plurality of optical fibers 10. An end portion 2a of the reinforcing tube 2 includes an end portion 23a of a jacket 23 and an end portion 21a of a tube 21 exposed from the end portion 23a of the jacket 23, and is attached and fixed to the inner component 4. An end portion 2b of the reinforcing tube 2 has an optical connector (not illustrated) containing the plurality of optical fibers 10 and being attached thereto, and is connected to another optical apparatus. The reinforcing tube 3 accommodates at least one of the plurality of optical fibers 10 accommodated in the reinforcing tube 2. An end portion 3a of the reinforcing tube 3 includes an end portion 33a of a jacket 33 and an end portion 31a of a tube 31 exposed from the end portion 33a of the jacket 33, and is attached and fixed to the inner component 4. In the embodiment, six reinforcing tubes 3 are fixed to the inner component 4. An end portion 3b of the reinforcing tube 3 has an optical connector (not illustrated) containing the plurality of optical fibers 10 and being attached thereto, and is connected to another optical device. The end portion 2b of the reinforcing tube 2 and the end portion 3b of the reinforcing tube 3 may be connected to another optical apparatus.

The inner component 4 includes a main body portion 6 and a cover member 7. The cover member 7 is attachable to and detachable from the main body portion 6. The outer component 5 covers the vicinity of the inner component 4. The outer component 5 includes an outer front portion 8 and an outer rear portion 9. The outer front portion 8 is engageable with the outer rear portion 9.

[Reinforcing Tube 2]

FIG. 3A is a cross-sectional view illustrating the reinforcing tube 2 used in the fan-out cord 1.

For example, the reinforcing tube 2 (an example of the first tube) has an outer diameter of 3 mm and accommodates 12 single-core optical fibers 10.

For example, the optical fiber 10 has a diameter of 0.25 mm and is formed by covering the vicinity of the optical fiber with a resin (for example, an ultraviolet curable resin). The optical fiber 10 may have a diameter of 0.9 mm and may be formed by covering the vicinity of the optical fiber with a primary coating and a secondary coating. Examples of the optical fiber include: an all-quartz fiber having a core and a cladding made of quartz glass; and a hard plastic clad fiber having a core made of quartz glass and a cladding made of a resin.

The reinforcing tube 2 includes the tube 21, the tension fiber 22, and the jacket 23. The tube 21 accommodates a plurality of optical fibers 10. For example, the tube 21 is a nylon (Ny) tube having an inner diameter of 1.3 mm and an outer diameter of 1.8 mm. The tension fiber 22 is an example of the tensile strength member. The tension fiber 22 is disposed to cover the vicinity of the tube 21. For example, the tension fiber 22 is an aramid fiber having tensile strength, such as Kevlar (registered trademark). The jacket 23 has a tubular shape and is provided to cover the vicinity of the tension fiber 22. The jacket 23 is made of, for example, a flame-retardant polyvinyl chloride (PVC) or a polyolefin resin.

[Reinforcing Tube 3]

FIG. 3B is a cross-sectional view illustrating the reinforcing tube 3 used in the fan-out cord 1.

For example, the reinforcing tube 3 (an example of the second tube) has an outer diameter of 2 mm and accommodates two single-core optical fibers 10.

The reinforcing tube 3 includes the tube 31, the tension fiber 32, and the jacket 33. The tube 31 accommodates at least one of the plurality of optical fibers 10 accommodated in the reinforcing tube 2. For example, the tube 31 is a nylon (Ny) tube having an inner diameter of 0.71 mm and an outer diameter of 0.95 mm. The tension fiber 32 is an example of the tensile strength member. The tension fiber 32 is disposed to cover the vicinity of the tube 31. For example, the tension fiber 32 is an aramid fiber having tensile strength, such as Kevlar (registered trademark). The jacket 33 has a tubular shape and is provided to cover the vicinity of the tension fiber 32. The jacket 33 is made of, for example, a flame-retardant polyvinyl chloride (PVC) or a polyolefin resin.

[Inner Component 4]

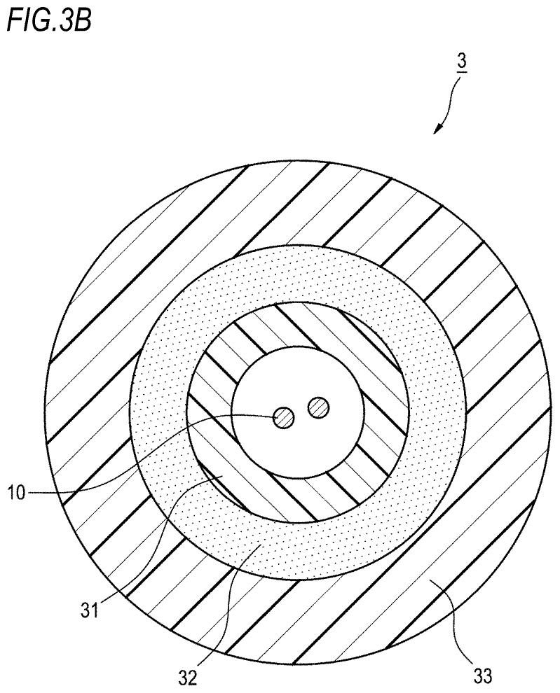

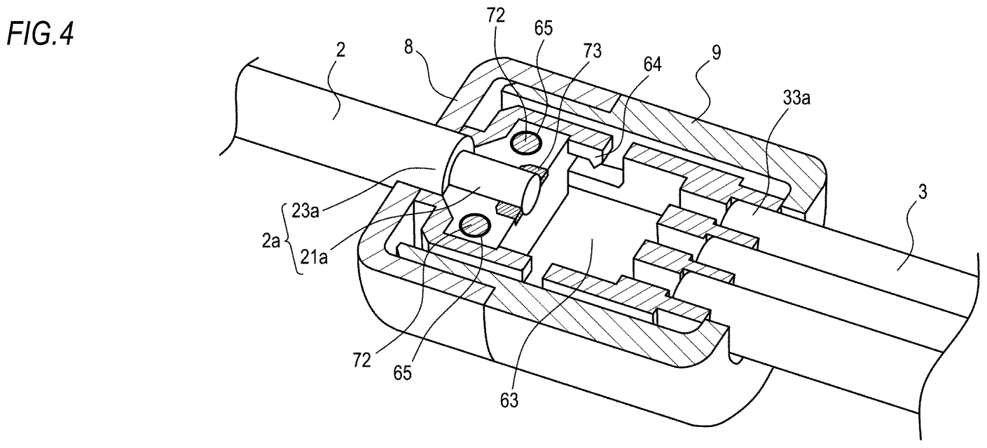

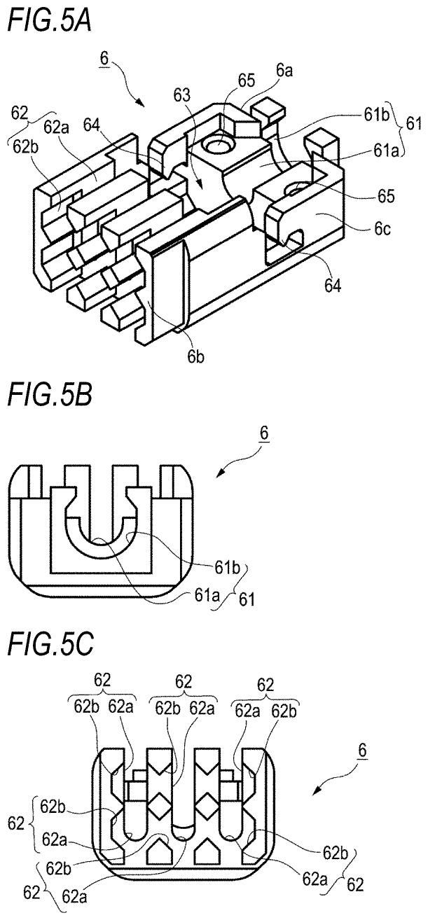

FIG. 4 is a partial cross-sectional view illustrating the fan-out cord 1 of FIG. 1. FIG. 5A is a perspective view illustrating the main body portion 6 of the inner component 4 according to the embodiment. FIG. 5B is a diagram illustrating the main body portion 6 of the inner component 4 when seen from a first fixing portion 61 side. FIG. 5C is a diagram illustrating the main body portion 6 of the inner component 4 when seen from a second fixing portion 62 side. FIG. 6 is a rear perspective view illustrating the cover member 7 of the inner component 4. FIG. 4 does not illustrate the optical fiber 10 and the tension fibers 22 and 32.

As illustrated in FIGS. 4 and 5A, the main body portion 6 includes the first fixing portion 61, a plurality of second fixing portions 62, an accommodation portion 63, engagement portions 64, and positioning holes 65. The first fixing portion 61 fixes the end portion 2a of the reinforcing tube 2 to the inner component 4. The second fixing portions 62 fix the end portions 3a of the corresponding reinforcing tubes 3 to the inner component 4. The accommodation portion 63 is provided between the first fixing portion 61 and the second fixing portion 62 and accommodates portions of the optical fibers 10 exposed from the reinforcing tube 2 and the reinforcing tubes 3. The engagement portion 64 engages with the tension fiber 22 exposed from the reinforcing tube 2. The positioning hole 65 is used for positioning the cover member 7 with respect to the main body portion 6.

The first fixing portion 61 is provided in the end portion 6a of the main body portion 6 and includes a recessed portion 61a and a guide portion 61b. The recessed portion 61a and the guide portion 61b are an example of the first recessed portion for positioning the reinforcing tube 2.

As illustrated in FIG. 4, in the end portion 2a of the reinforcing tube 2, the recessed portion 61a accommodates the end portion 21a of the tube 21 exposed from the end portion 23a of the jacket 23. For example, the recessed portion 61a has an arc-shaped cross-section along the external shape of the tube 21 of the reinforcing tube 2 as illustrated in FIG. 5B and extends in the front-rear direction as illustrated in FIG. 5A. The end portion 21a of the tube 21 of the reinforcing tube 2 is fixed to the inner component 4 using an adhesive in a state where the end portion 21a is accommodated in the recessed portion 61a. The recessed portion 61a has an arc-shaped cross-section along the external shape of the tube 21 of the reinforcing tube 2, but the present invention is not limited thereto. The recessed portion 61a may have a cross-section having another shape such as a V-shape that can be positioned and fixed.

The guide portion 61b is provided outside the recessed portion 61a in the end portion 6a of the main body portion 6 and accommodates the end portion 23a of the jacket 23 of the reinforcing tube 2. For example, as illustrated in FIG. 5B, the guide portion 61b has an arc-shaped cross-section along the external shape of the jacket 23 of the reinforcing tube 2 (that is, the external shape of the reinforcing tube 2). The guide portion 61b has an arc-shaped cross-section along the external shape of the reinforcing tube 2, but the present invention is not limited thereto. The guide portion 61b may have a cross-section having another shape such as a V-shape that can be guided and fixed.

The second fixing portions 62 are provided in an end portion 6b that is positioned opposite to the end portion 6a of the main body portion 6 in the front-rear direction. In the embodiment, the main body portion 6 includes six second fixing portions 62 corresponding to six reinforcing tubes 3. In the end portion 6b of the main body portion 6, three second fixing portions 62 are arranged adjacent to each other in parallel on a lower stage, and three second fixing portions 62 are arranged adjacent to each other in parallel on an upper stage.

The second fixing portion 62 includes a recessed portion 62a and a guide portion 62b. The recessed portion 62a and the guide portion 62b are examples of the second recessed portions for positioning the reinforcing tube 3. In the end portion 3a of the reinforcing tube 3, the recessed portion 62a accommodates the end portion 31a of the tube 31 exposed from the end portion 33a of the jacket 33. For example, the recessed portion 62a has an arc-shaped cross-section along the external shape of the tube 31 of the reinforcing tube 3 as illustrated in FIG. 5C and extends in the front-rear direction as illustrated in FIG. 5A. In the embodiment, the recessed portions 62a of the upper stage and the recessed portions 62a of the lower stage in the same column are integrally formed, and the end portions 31a of the tubes 31 of the reinforcing tubes 3 of the upper and lower stages are accommodated in the integrated recessed portions 62a. The end portion 31a of the tube 31 of the reinforcing tube 3 is fixed to the inner component 4 using an adhesive in a state where the end portion 31 is accommodated in the recessed portion 62a.

The guide portion 62b is provided outside of the recessed portion 62a in the end portion 6b of the main body portion 6 and accommodates the end portion 33a of the jacket 33 of the reinforcing tube 3. For example, as illustrated in FIG. 5C, the guide portion 62b has an octagonal cross-section in contact with a part of the external shape of the jacket 33 of the reinforcing tube 3 (that is, the external shape of the reinforcing tube 3). The guide portion 62b has an octagonal cross-section, but the present invention is not limited thereto. The guide portion 62b may have a cross-section having another shape such as an arc shape or a V-shape along the external shape of the reinforcing tube 3 that can be guided and fixed.

As illustrated in FIGS. 4 and 5A, the accommodation portion 63 is a space surrounded by the first fixing portion 61, the second fixing portions 62, and two side surfaces 6c and 6c of the main body portion 6. The accommodation portion 63 has a predetermined length in the front-rear direction such that each of the optical fibers 10 exposed from the reinforcing tube 2 is prevented from being rapidly bent when accommodated in the reinforcing tube 3.

The engagement portion 64 engages with the tension fiber 22 exposed from the reinforcing tube 2. As illustrated in FIGS. 4 and 5A, the engagement portion 64 is provided in each of the two side surfaces 6c of the main body portion 6. The engagement portion 64 is provided in, for example, a portion of the side surface 6c of the main body portion 6 constituting the accommodation portion 63. The engagement portion 64 has a hook shape and includes: a linear portion that linearly extends along the side surface 6c; and a tip portion that extends downward from a lower surface of the linear portion. The tension fiber 22 exposed from the reinforcing tube 2 engages with the engagement portion 64 such that the tension fiber 22 can be temporarily fixed.

The positioning hole 65 is provided on opposite sides of the recessed portion 61a of the first fixing portion 61. The positioning hole 65 is a cylindrical hole that extends in the up-down direction, and guides a positioning portion 72 (refer to FIG. 6) of the cover member 7 when the cover member 7 is attached to the main body portion 6. The positioning hole 65 is not limited to the cylindrical hole. For example, the positioning hole 65 may have a quadrangular or octagonal cross-section in contact with a part of the positioning portion 72 of the cover member 7. In addition, only one positioning hole 65 may be provided.

As illustrated in FIG. 6, the cover member 7 includes a top plate portion 71, the positioning portion 72, a first cover portion 73, a second cover portion 74, a third cover portion 75. The top plate portion 71 is formed to cover the upper portion of the main body portion 6. The positioning portion 72 is, for example, a cylinder that protrudes downward from a lower surface 71A of the top plate portion 71. When the cover member 7 is attached to the main body portion 6, the positioning portion 72 is inserted and guided into the positioning hole 65 of the main body portion 6. The first cover portion 73 is formed to cover an upper rear end portion (portion facing the reinforcing tube 3) of the recessed portion 61a of the first fixing portion 61. The second cover portion 74 is formed to cover the upper portion of the guide portion 61b of the first fixing portion 61. The third cover portion 75 is formed to cover the upper portion of the recessed portion 62a of the second fixing portion 62. The first cover portion 73 covers a part of the upper portion of the recessed portion 61a of the first fixing portion 61 but may cover the entire upper portion of the recessed portion 61a of the first fixing portion 61. In addition, the third cover portion 75 covers the entire upper portion of the recessed portion 62a of the second fixing portion 62 but may cover a part of the upper portion of the recessed portion 62a.

[Outer Component 5]

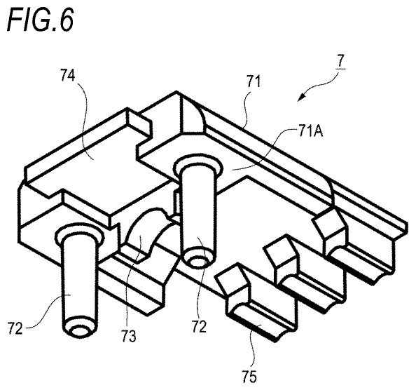

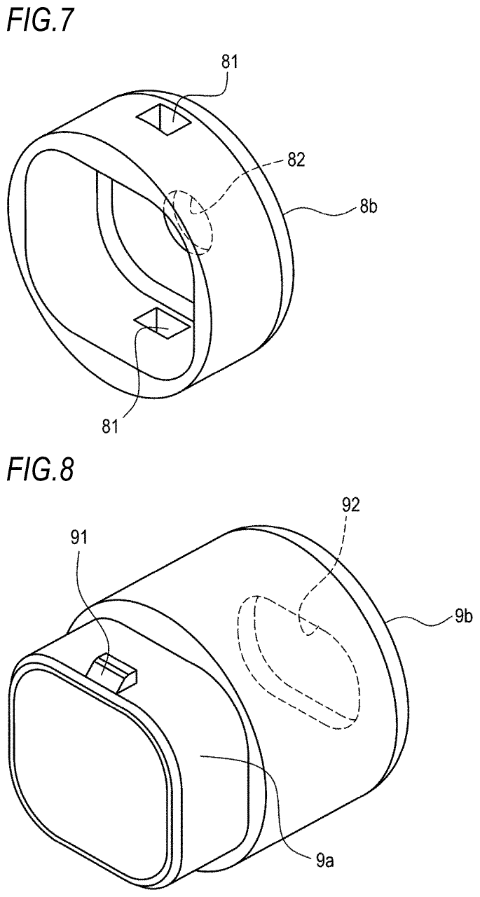

FIG. 7 is a perspective view illustrating the outer front portion 8 of the outer component 5. FIG. 8 is a perspective view illustrating the outer rear portion 9 of the outer component 5.

As illustrated in FIGS. 7 and 8, the outer component 5 accommodates the inner component 4 in an inner portion having a quadrangular cylindrical bottom surface. In addition, the outer component 5 has a bottom surface with a circular cylindrical external shape.

As illustrated in FIG. 7, the outer front portion 8 includes an attachment hole 81 and a through-hole 82. The through-hole 82 is an example of a first through-hole or a second through-hole. The attachment hole 81 is formed at two positions of the side surface 8a of the outer front portion 8. The through-hole 82 is formed in an upper surface 8b of the outer front portion 8. For example, the through-hole 82 is a circular through-hole having a diameter larger than the diameter of the reinforcing tube 2. The positions and number of the attachment holes 81 are not limited to the above-described example. In addition, the through-hole 82 is not limited to a circular shape and may have another shape as long as the reinforcing tube 2 can be inserted thereinto.

A tip portion 9a of the outer rear portion 9 is inserted into the outer front portion 8. The tip portion 9a of the outer rear portion 9 has a bottom surface with a quadrangular cylindrical external shape to correspond to an inner surface of the outer front portion 8. The outer rear portion 9 includes an attachment pawl 91 and a through-hole 92. The attachment pawl 91 is formed at two positions of an outer surface of the tip portion 9a of the outer rear portion 9 to correspond to the attachment hole 81 of the outer front portion 8. The through-hole 92 is formed in a bottom surface 9b of the outer rear portion 9. For example, the through-hole 92 is a quadrangular through-hole having a diameter larger than the entire shape of the plurality of reinforcing tubes 3 arranged in two stages (refer to FIG. 2). The positions and number of the attachment pawls 91 are not limited to the above-described example. In addition, the through-hole 92 is not limited to a quadrangular shape and may have another shape as long as the reinforcing tubes 3 can be inserted thereinto.

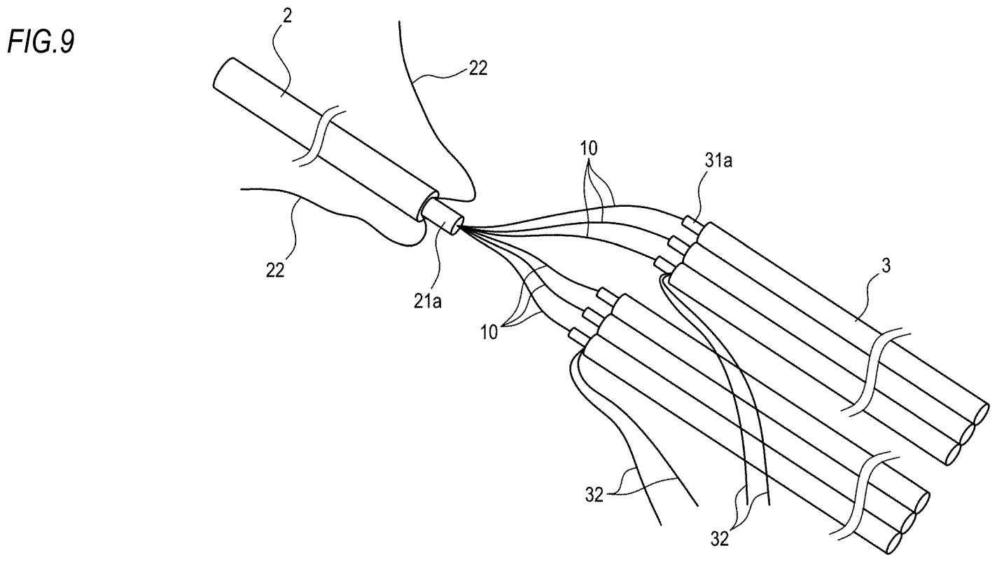

Next, an example of a method of manufacturing the fan-out cord 1 will be described based on FIGS. 9 to 16. FIGS. 9 to 16 are diagrams illustrating each of the steps of the method of manufacturing the fan-out cord 1. FIGS. 9 to 16 schematically illustrate the tension fibers, in which two tension fibers exposed from the reinforcing tube 2 and two tension fibers exposed from the reinforcing tube 3 fixed to the upper stage and the lower stage only on the leftmost side of the second fixing portion 62 are illustrated.

First, as illustrated in FIG. 9, a plurality (here, six) of optical fibers 10 are collectively accommodated in the reinforcing tube 2. The optical fibers 10 are fixed inside the tube 21 of the reinforcing tube 2 by applying an adhesive (not illustrated) from the end portion 21a to the inside of the tube 21 of the reinforcing tube 2. In addition, among the optical fibers 10 exposed from the reinforcing tube 2, a predetermined number (herein, one) of optical fibers 10 are accommodated in the reinforcing tube 3. The optical fibers 10 are accommodated in the reinforcing tube 3 such that the length of a portion exposed between the reinforcing tube 2 and the reinforcing tube 3 is longer than the length of the inner component 4 in the front-rear direction.

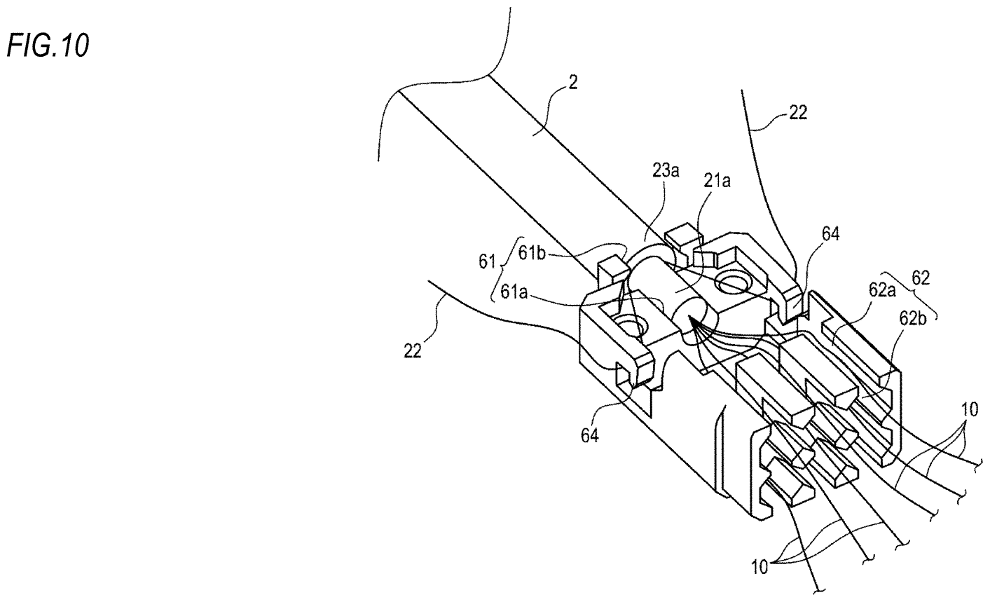

Next, as illustrated in FIG. 10, the reinforcing tube 2 is fixed to the inner component 4. The end portion 21a of the tube 21 of the reinforcing tube 2 and the end portion 23a of the jacket 23 are positioned and fixed to the recessed portion 61a and the guide portion 61b of the first fixing portion 61, respectively. The end portion 21a of the tube 21 of the reinforcing tube 2 is strongly fixed to the recessed portion 61a of the first fixing portion 61 by applying an adhesive (not illustrated). In addition, the tension fibers 22 exposed from the reinforcing tube 2 engage with the engagement portions 64 of the main body portion 6 to be temporarily fixed. The optical fibers 10 exposed from the reinforcing tube 2 are disposed in the corresponding second fixing portions 62 through the accommodation portion 63, respectively.

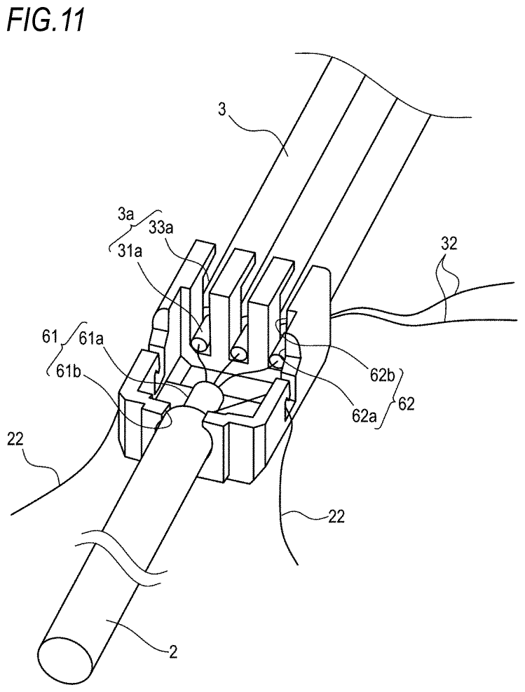

Next, as illustrated in FIG. 11, the reinforcing tube 3 is fixed to the second fixing portion 62 of the lower stage among the second fixing portions 62. The end portion 31a of the tube 31 of the reinforcing tube 3 and the end portion 33a of the jacket 33 are positioned and fixed to the recessed portion 62a and the guide portion 62b of the second fixing portion 62, respectively. The end portion 31a of the tube 31 of the reinforcing tube 3 is strongly fixed to the recessed portion 62a of the second fixing portion 62 by applying an adhesive (not illustrated). In addition, the tension fibers 32 exposed from the reinforcing tube 3 are folded and taken out to the outside of the main body portion 6 through the guide portion 62b and the like. FIG. 11 does not illustrate three optical fibers 10 and three reinforcing tubes 3 disposed in the upper stage.

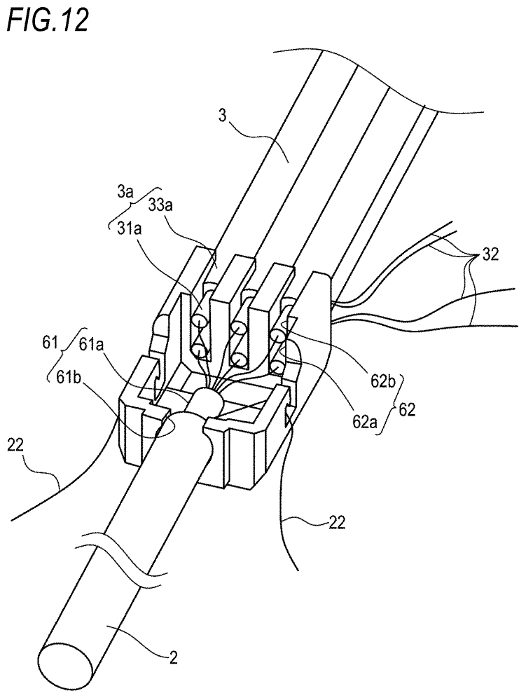

Next, as illustrated in FIG. 12, the reinforcing tube 3 is fixed to the second fixing portion 62 of the upper stage among the second fixing portions 62. The end portion 31a of the tube 31 of the reinforcing tube 3 and the end portion 33a of the jacket 33 are positioned and fixed to the recessed portion 62a and the guide portion 62b of the second fixing portion 62, respectively. The end portion 31a of the tube 31 of the reinforcing tube 3 is strongly fixed to the recessed portion 62a of the second fixing portion 62 by applying an adhesive (not illustrated). In addition, the tension fibers 32 exposed from the reinforcing tube 3 are folded and taken out to the outside of the main body portion 6 through the guide portion 62b and the like.

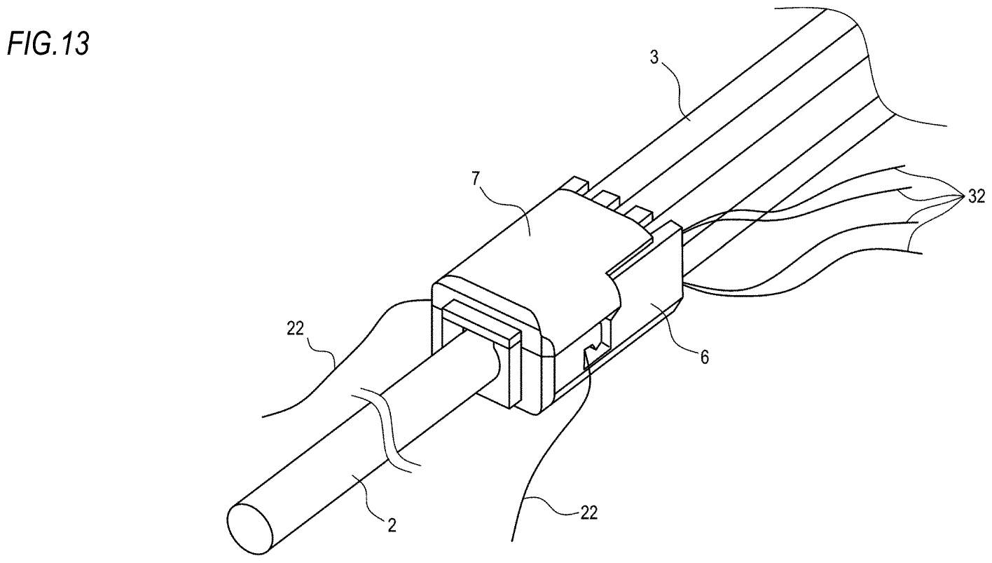

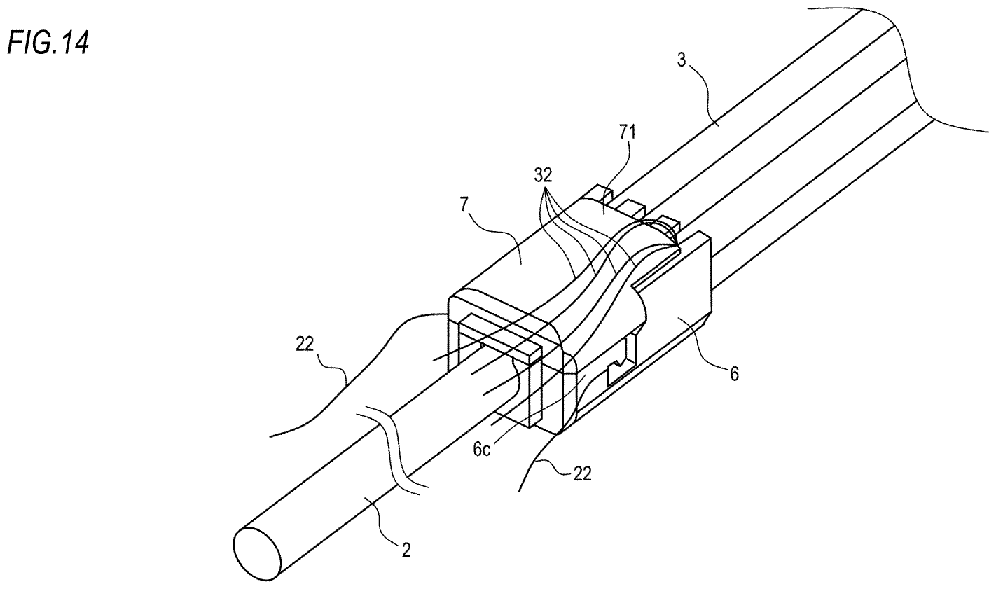

Next, as illustrated in FIG. 13, the cover member 7 is attached to the main body portion 6. The positioning portion 72 of the cover member 7 is inserted and guided into the positioning hole 65 of the main body portion 6. As illustrated in FIG. 14, the tension fibers 22 and 32 are fixed to the inner component 4. The tension fibers 32 exposed from the second fixing portion 62 are folded on the upper surface of the top plate portion 71 of the cover member 7 are strongly fixed to the top plate portion 71 of the cover member 7 through an adhesive (not illustrated). In addition, the tension fibers 22 exposed from the engagement portions 64 come into contact with the side surface 6c of the main body portion 6 to be strongly fixed to the side surface 6c of the main body portion 6 through an adhesive (not illustrated). The tension fibers 22 and 32 are cut short as necessary so as not to protrude from the outer component 5.

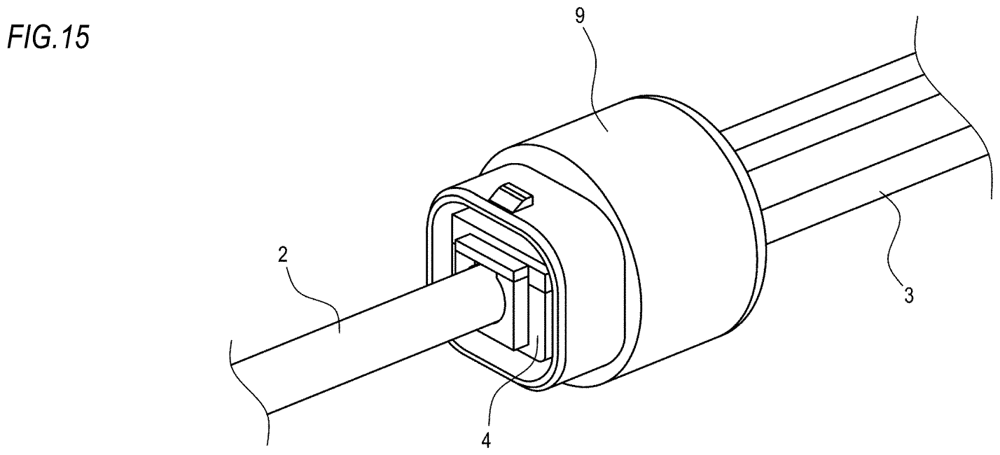

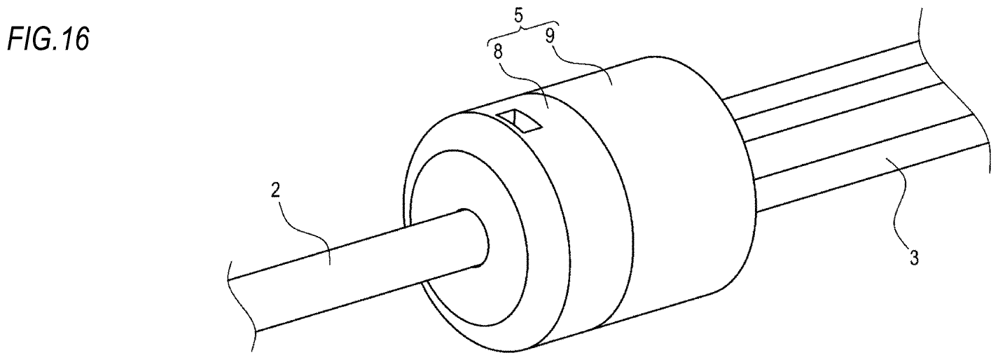

Next, as illustrated in FIG. 15, the outer rear portion 9 is disposed in the vicinity of the inner component 4 and accommodates the inner component 4 therein. A rear end of the reinforcing tube 3 is inserted into the through-hole 92 of the outer rear portion 9 and moves the outer rear portion 9 up to the inner component 4 along the reinforcing tube 3. As illustrated in FIG. 16, the outer front portion 8 is attached to the outer rear portion 9. A front end of the reinforcing tube 2 is inserted into the through-hole 82 of the outer front portion 8 and moves the outer front portion 8 up to the outer rear portion 9 along the reinforcing tube 2. The outer front portion 8 is covered with the tip portion 9a of the outer rear portion 9 such that the attachment pawl 91 of the outer rear portion 9 engages with the attachment hole 81 of the outer front portion 8.

As described above, in the embodiment, the inner component 4 fixes the reinforcing tube 2 and the reinforcing tubes 3. Therefore, since the reinforcing tube 2 and the reinforcing tubes 3 do not move with respect to the inner component 4 when the vicinity of the inner component 4 is covered with the outer component 5, it is not necessary to increase the outer component 5. As a result, the compact fan-out cord can be provided.

In addition, the accommodation portion 63 accommodates the plurality of optical fibers 10 exposed from the reinforcing tube 2 and the reinforcing tubes 3. Therefore, the respective optical fibers 10 exposed from the reinforcing tube 2 can be prevented from being rapidly bent.

In addition, the engagement portion 64 engages with the tension fiber 22 exposed from the reinforcing tube 2. Therefore, when the attachment operation or the like of the reinforcing tube 3 is performed, the tension fibers 22 do not interfere with the attachment operation, and the attachment operation or the like of the reinforcing tubes 3 can be easily performed. In addition, the engagement portion 64 is formed in the side surface 6c of the accommodation portion 63. Therefore, the engagement portion 64 can be simply formed while efficiently using the side surface 6c of the accommodation portion 63.

In addition, the second fixing portions 62 are fixed to the plurality of reinforcing tubes 3, respectively. Therefore, the reinforcing tubes 3 can be individually positioned. In addition, the plurality of second fixing portions 62 are disposed in two stages. Therefore, the inner component 4 is not spread in the left-right direction, and the compact inner component 4 can be manufactured.

In addition, the first fixing portion 61 includes the recessed portion 61a and the guide portion 61b for positioning the reinforcing tube 2. Therefore, the positioning operation of the reinforcing tube 2 can be easily performed.

In addition, the recessed portion 61a accommodates the tube 21 of the reinforcing tube 2, and the tube 21 of the reinforcing tube 2 adheres and is fixed to the recessed portion 61a. Therefore, the tube 21 of the reinforcing tube 2 can be easily positioned and fixed to the inner component 4. In addition, the tube 21 of the reinforcing tube 2 can be strongly fixed to the inner component 4.

In addition, the guide portion 61b accommodates the jacket 23 of the reinforcing tube 2. Therefore, the jacket 23 of the reinforcing tube 2 can be easily positioned and fixed to the inner component 4. In addition, the jacket 23 of the reinforcing tube 2 is guided and fixed by the guide portion 61b. Therefore, when the reinforcing tube 2 moves in the radial direction, the tube 21 can be prevented from moving together and being separated from the recessed portion 61a.

In addition, the second fixing portion 62 includes the recessed portion 62a and the guide portion 62b for positioning the reinforcing tubes 3. Therefore, the positioning operation of the reinforcing tubes 3 can be easily performed.

In addition, the recessed portion 62a accommodates the tube 31 of the reinforcing tube 3, and the tube 31 of the reinforcing tube 3 adheres and is fixed to the recessed portion 62a. Therefore, the tube 31 of the reinforcing tube 3 can be easily positioned and fixed to the inner component 4. In addition, the tube 31 of the reinforcing tube 3 can be strongly fixed to the inner component 4.

In addition, the guide portion 62b accommodates the jacket 33 of the reinforcing tube 3. Therefore, the jacket 33 of the reinforcing tube 3 can be easily positioned and fixed to the inner component 4. In addition, the jacket 33 of the reinforcing tube 3 is guided and fixed by the guide portion 62b. Therefore, when the reinforcing tube 3 moves in the radial direction, the tube 31 can be prevented from moving together and being separated from the recessed portion 62a.

In addition, the main body portion 6 includes the positioning hole 65, and the cover member 7 includes the positioning portion 72. Therefore, the cover member 7 can be positioned with respect to the main body portion 6. In addition, by providing at least two positioning holes 65, the cover member 7 can be guided to the main body portion 6 without the cover member 7 rotating when attached to the main body portion 6.

In addition, the cover member 7 includes the top plate portion 71. Therefore, the reinforcing tube 2, the reinforcing tubes 3, and optical fibers 10 can be prevented from moving upward from the main body portion 6 and being separated from a predetermined position.

In addition, the cover member 7 includes the first cover portion 73. Therefore, the tube 21 of the reinforcing tube 2 accommodated in the recessed portion 61a of the first fixing portion 61 can be prevented from jumping upward.

In addition, the cover member 7 includes the second cover portion 74. Therefore, the jacket 23 of the reinforcing tube 2 accommodated in the guide portion 61b of the first fixing portion 61 can be prevented from moving upward and being separated from the guide portion 61b.

In addition, the cover member 7 includes the third cover portion 75. Therefore, the tube 31 of the reinforcing tube 3 accommodated in the recessed portion 62a of the second fixing portion 62 can be prevented from moving upward and being separated from the recessed portion 62a.

In addition, the inner component 4 includes the main body portion 6 and the cover member 7. Therefore, in a state where the cover member 7 is separated, the reinforcing tube 2 and the reinforcing tubes 3 can be attached to the main body portion 6. As a result, the attachment operation of the reinforcing tube 2 and the reinforcing tubes 3 can be easily performed.

In addition, the outer component 5 is formed to cover the vicinity of the inner component 4. Therefore, the inner component 4 can be protected from the outside. In addition, the outer component 5 includes the outer front portion 8 and the outer rear portion 9 that are engageable with each other. Therefore, the attachment operation of the outer component 5 can be easily performed.

In addition, the outer component 5 includes the through-hole 82 into which the reinforcing tube 2 is inserted and the through-hole 92 into which the reinforcing tubes 3 are inserted. Therefore, the reinforcing tube 2 can be moved up to the inner component 4 while inserting the tip of the reinforcing tube 2 into the through-hole 82. Therefore, the attachment operation of the outer component 5 can be easily performed. In addition, the reinforcing tubes 3 can be moved up to the inner component 4 while inserting the rear end of the reinforcing tubes 3 into the through-hole 92. Therefore, the attachment operation of the outer component 5 can be easily performed.

In addition, the outer rear portion 9 includes the attachment pawl 91, and the outer front portion 8 includes the attachment hole 81. Therefore, the attachment pawl 91 of the outer rear portion 9 engages with the attachment hole 81 of the outer front portion 8 such that the outer front portion 8 and the outer rear portion 9 can be fixed to each other.

The optical fibers 10 are fixed inside the tube 21 of the reinforcing tube 2 by applying an adhesive (not illustrated) to the inside of the tube 21 of the reinforcing tube 2. When the tube 21 shrinks due to heat, the optical fibers 10 in the tube 21 may be pressed out to the inner component 4 and bent in the inner component 4. However, since the optical fibers 10 adhere and are fixed into the tube 21, the optical fibers 10 can be prevented from being pressed out to the inner component 4 due to thermal shrinkage of the tube 21.

Hereinabove, the present invention has been described in detail with reference to the embodiment. However, it is obvious to those skilled in the art that various changes or modifications can be made within a range not departing from the spirit and scope of the present invention. In addition, the numbers, positions, shapes, and the like of the components described above are not limited to those in the embodiment and can be changed to those suitable for implementing the present invention.

In the embodiment, 12 optical fibers 10 are accommodated in the reinforcing tube 2 in a state where the optical fibers 10 are separated from each other. However, the present invention is not limited to this configuration. The number and aspect of the optical fibers 10 vary depending on the use of the fan-out cord 1 and the structure of an optical apparatus to be connected. For example, 12 optical fibers 10 may be arranged in parallel to each other and the vicinity thereof may be covered with a resin (for example, an ultraviolet curable resin) so as to be formed as a 12-core optical fiber ribbon. Instead of the 12-core optical fiber ribbon, a plurality of 4-core or 8-core optical fiber ribbons may be accommodated in the reinforcing tube 2. In addition, the reinforcing tube 2 may accommodate 24 single-core optical fibers or a 24-core optical fiber ribbon. When the optical fiber ribbon 10 is accommodated in the reinforcing tube 2, the resin is removed from a portion of the optical fiber ribbon 10 exposed from the reinforcing tube 2, a plurality of optical fibers 10 are separated from each other, and a predetermined number of optical fibers 10 are accommodated in the reinforcing tube 3.

In addition, in the embodiment, 2 optical fibers 10 are accommodated in the reinforcing tube 3. However, the present invention is not limited to this configuration. The number of the optical fibers 10 varies depending on the use of the fan-out cord 1 and the structure of an optical apparatus to be connected. For example, the reinforcing tube 3 may accommodate one optical fiber 10.

In addition, in the embodiment, the first fixing portion 61 includes the recessed portion 61a and the guide portion 61b. However, the present invention is not limited to this configuration. For example, when the tube 21 is not exposed from the jacket 23 in the end portion 2a of the reinforcing tube 2, the recessed portion 61a may accommodate the end portion 23a of the jacket 23 of the reinforcing tube 2, and the first fixing portion 61 does not necessarily include the guide portion 61b.

In addition, in the embodiment, three second fixing portions 62 are arranged adjacent to each other in parallel on the lower stage, and three second fixing portions 62 are arranged adjacent to each other in parallel on the upper stage. However, the present invention is not limited to this configuration. The number of second fixing portions 62, the number of second fixing portions 62 arranged in parallel on one stage, and the number of stages vertically disposed are determined depending on the number of reinforcing tubes 3 fixed to the inner component 4.

In addition, in the embodiment, the recessed portion 62a accommodates the end portions 31a of the tubes 31 of the reinforcing tubes 3 of the upper and lower stages in the same column. However, the present invention is not limited to this configuration. For example, the recessed portion 62a may accommodate the end portion 31a of the tube 31 of each of the reinforcing tubes 3. In this case, the recessed portion 62a of the lower stage may be formed as a through-hole having an arc-shaped cross-section along the external shape of the tube 31 of the reinforcing tube 3 and having an upper portion in which an opening is not formed. In addition, the recessed portion 62a may have a cross-section having another shape such as a V-shape that can be positioned and fixed.

In addition, in the embodiment, the second fixing portion 62 includes the recessed portion 62a and the guide portion 62b. However, the present invention is not limited to this configuration. For example, when the tube 31 is not exposed from the jacket 33 in the end portion 3a of the reinforcing tube 3, the recessed portion 62a may accommodate the end portion 33a of the jacket 33 of the reinforcing tube 3, and the second fixing portion 62 does not necessarily include the guide portion 62b. In addition, the main body portion 6 includes a plurality of second fixing portions 62. However, the present invention is not limited to this configuration. For example, the main body portion 6 may include one second fixing portion 62 such that a plurality of reinforcing tubes 3 are collectively fixed to the inner component 4 by the single second fixing portion 62.

In addition, in the embodiment, the engagement portion 64 is provided on the two side surfaces 6c of the main body portion 6 but may be provided on only one side surface 6c. In addition, the engagement portion 64 has a hook shape but may have another shape as long as the engagement portion 64 can engage with the tension fibers 22. In addition, the engagement portion 64 is provided on the side surface 6c of the accommodation portion 63. However, the present invention is not limited to this configuration. For example, the engagement portion 64 may be provided in the first fixing portion 61 or in a portion of the side surface 6c positioned outside the first fixing portion 61.

In addition, in the embodiment, the outer front portion 8 and the outer rear portion 9 are formed to be separated in the front-rear direction. However, the present invention is not limited to this configuration. The outer front portion 8 and the outer rear portion 9 may be formed to be separated in a direction perpendicular to the front-rear direction. In addition, the outer rear portion 9 is inserted into the outer front portion 8. However, the present invention is not limited to this configuration. The outer front portion 8 may have an attachment pawl such that the attachment pawl engages with the attachment hole of the outer rear portion 9 when the outer front portion 8 is inserted into the outer rear portion 9.

What is claimed is:

1. A base component used for a fan-out cord, the base component includes a main body portion and the main body portion comprising:
a first fixing portion that fixes a first tube accommodating a plurality of optical fibers and a tensile strength member;
at least one second fixing portion that fixes a plurality of second tubes each of which accommodates at least one of the plurality of optical fibers;
an engagement portion that engages with the tensile strength member exposed from the first tube; and
an accommodation portion that accommodates the plurality of optical fibers exposed from each of the first tube and the plurality of second tubes between the first fixing portion and the at least one second fixing portion.

2. The base component according to claim 1, wherein
the at least one second fixing portion is a plurality of second fixing portions which fix each of the plurality of second tubes.

3. The base component according to claim 2, wherein
second fixing portion groups in which at least two of the plurality of second fixing portions are arranged adjacent to each other in parallel are disposed in multiple stages.

4. The base component according to claim 2, wherein
the first fixing portion has a first recessed portion for positioning the first tube, and
the plurality of second fixing portions respectively have a plurality of second recessed portions for positioning the plurality of second tubes.

5. The base component according to claim 1, further comprising:
a cover member that is attachable to and detachable from the main body portion.

6. A fan-out cord comprising:
a plurality of optical fibers;
a first tube that accommodates the plurality of optical fibers and a tensile strength member;
a plurality of second tubes each of which accommodates at least one of the plurality of optical fibers; and
a base component that fixes the first tube and the plurality of second tubes, wherein
the base component includes a main body portion and the main body portion includes
a first fixing portion that fixes the first tube,
a second fixing portion that fixes the plurality of second tubes,
an engagement portion that engages with the tensile strength member exposed from the first tube, and
an accommodation portion that accommodates the plurality of optical fibers exposed from each of the first tube and the plurality of second tubes between the first fixing portion and the at least one second fixing portion.

7. The fan-out cord according to claim 6, further comprising a protective material that covers the vicinity of the base component.

8. The fan-out cord according to claim 6, wherein
the protective material includes two components that are engageable with each other.

9. The fan-out cord according to claim 7, wherein
the protective material includes a first through-hole into which the first tube is inserted and a second through-hole into which the plurality of second tubes are inserted.

10. A method of manufacturing a fan-out cord, the method comprising:
a step of accommodating a plurality of optical fibers in a first tube;
a step of accommodating each of at least one of the plurality of optical fibers in a plurality of second tubes;
a step of fixing the first tube to a base component;
a step of engaging a tensile strength member accommodated in the first tube with the base component; and
a step of fixing the plurality of second tubes to the base component.

11. The method of manufacturing a fan-out cord according to claim 10, further comprising a step of covering the vicinity of the base component with a protective material.
